(19) United States
(12) Patent Application Publication
(10) Pub. No.: US 2007/0143419 A1
(43) Pub. Date: Jun. 21, 2007

(54) E-mail attachment as one-time clickable link

(75) Inventor: Dirk-Jaap Plas, Enschede (NL)

Correspondence Address: PATTERSON & SHERIDAN, LLP/;LUCENT TECHNOLOGIES, INC, 595 SHREWSBURY AVENUE, SHREWSBURY, NJ, 07702, US

(73) Assignee: Lucent Technologies Inc.

(21) Appl. No.: 11/311,187

(22) Filed: Dec. 19, 2005

(51) Int. Cl. G06F 15/16

(52) U.S. Cl. 709/206

(57) ABSTRACT

An e-mail attachment as a one-time clickable link reduces the overhead of sending a potentially large number of e-mails with potentially large attachments to a mailing list. A method of providing the subscribers to the mailing list with the same information just as secure by the use of a one-time clickable link is provided.

### FIELD OF THE INVENTION

The present invention relates generally to data networking and, in particular, relates to e-mail applications.

### BACKGROUND OF THE INVENTION

Nowadays mailing lists are a common good in the Internet world that enables distribution of information to specific groups of people. Users can subscribe themselves to receive information for a specific topic of interest. Mailing list systems provide a means for the information providers to send information only to the people that are interested in the information or only to people who have been authorized to be subscribed to the mailing list.

Mailing lists work fine as long as the size of the message is small. Large messages not only put a burden on the transport network but also on the recipients of the messages. One option is to store the attachment somewhere on the Internet and provide a link to it in the e-mail message instead of attaching the information. However no solution exists to fully automate this task, which means that this needs to be done manually. When a link is provided in the e-mail message, the information is now publicly available by an Internet uniform resource locator (URL) and more easily available to non-subscribers. There are a number of ways to protect the information, such as authenticating the subscriber before authorizing access to the information. However, this makes it more difficult for the subscriber to access the information.

### SUMMARY

Various deficiencies of the prior art are addressed by various exemplary embodiments of the present invention of an e-mail attachment as a one-time clickable link.

One embodiment is a method for processing messages. Information from an attachment in an e-mail message is stored, before the e-mail message is sent to a number of subscribers to a mailing list. The attachment is replaced in the e-mail message with a link for accessing the information that was in the attachment, before the e-mail message is sent to the subscribers. The e-mail message with the link is sent to the subscribers. When one of the subscribers clicks on the link, the information that was in the attachment is provided. The link is no longer valid and useable after first usage and a new link to access the information will be sent to the subscriber it was originally sent to. Another embodiment is a computer readable medium storing instructions for performing this method.

Another embodiment is a system for processing messages, including a mailing list server and a storage device. The mailing list server receives an e-mail message with an attachment and sends a modified e-mail message to the subscribers via a plurality of mail servers. The e-mail message is modified so that the attachment is replaced by a link. The storage device is accessible by the mailing list server and stores the attachment. When one of the subscribers clicks on the link, the storage device provides the information from the attachment.

### BRIEF DESCRIPTION OF THE DRAWINGS

The teachings of the present invention can be readily understood by considering the following detailed description in conjunction with the accompanying drawings, in which:

FIG. 1 is a flow chart showing an exemplary embodiment of a method of responding to a subscriber request for an attachment;

FIG. 2 is a block diagram showing a prior art system for providing e-mail attachments to subscribers of a mailing list;

FIG. 3 is a flow chart showing an exemplary embodiment of a method of providing a mailing list;

FIG. 4 is a block diagram showing an exemplary embodiment of a system for sending a link instead of an e-mail attachment to subscribers of a mailing list; and

FIG. 5 is a high level block diagram showing a computer.

To facilitate understanding, identical reference numerals have been used, where possible, to designate identical elements that are common to the figures.

### DETAILED DESCRIPTION OF THE INVENTION

The invention will be primarily described within the general context of embodiments of an e-mail attachment as a one-time clickable link in e-mail messages processed by a mailing list system. However, those skilled in the art and informed by the teachings herein will realize that the invention is applicable generally to any messaging systems, any large amount of information in a message, whether it is an attachment or not, any computing system, including mailing list systems, and messages other than e-mail, such as messages in other applications such as enterprise applications or database applications.

One exemplary embodiment is a one-time clickable link that overcomes the problems associated with sending a large e-mail attachment to a mailing list. Rather than sending the attachment to members of the mailing list, the attachment is stored in a storage medium by a mailing list system, when an e-mail message to be sent to members of the mailing list includes any attachment. A mailing list is a list of e-mail addresses of members or subscribers that is stored by the mailing list system. The mailing list may be stored on the same storage medium as the attachments or a different one. A storage medium is any kind of storage device, such as the memory device in the mailing list server that runs the mailing list system or a storage device on a network that is accessible by the mailing list system. The mailing list system is any kind of computing device, such as a mail or web server, that runs a computer program that operates to provide at least one mailing list service.

In this exemplary embodiment, a link is generated by the mailing list system and sent to each subscriber on the mailing list. A link is any kind of address on a network, such as a uniform resource locator (URL) for the Internet. In one embodiment, the link is unique. In one embodiment, the link is a one-time clickable link, i.e., a link that is only valid for a one-time access. In one embodiment, the link is valid for a limited time period. In one embodiment, the link is valid for a predetermined number of accesses. In one embodiment, the mailing list system stores the link and associates it with the subscriber it was provided to. In one embodiment, the mail list system also stores whether the link provided is still valid. In one embodiment, the mailing list system stores the information that is accessible by the link.

In this exemplary embodiment, the subscriber receives an e-mail message with a link to the information that would otherwise have been attached to the e-mail message. In one embodiment, the mailing list system extracts attachments from e-mail messages, stores them, and replaces them with links before they are forwarded. In one embodiment, the mailing list system checks whether the link is valid, when the subscriber clicks on the link. If the link is valid, the information is provided to the subscriber. The information may be provided in many ways, such as on a web page or even sent by e-mail. Validation may include any number of criteria, such as authentication, authorization and other security measures. Validation prevents a subscriber from forwarding information to someone who is not a subscriber. Validation also allows the mailing list system to determine who forwarded the information, when a unique link was sent to each subscriber and the unique link was stored and associated with identifying information about the subscriber. However, validation, such as additional authentication and authorization, are not used in one embodiment in order to make it easier to use.

In one embodiment, the link is invalidated after the information is provided. In one embodiment, an entry in a database storing information about the mailing list is deleted after the information is provided. In one embodiment, once the subscriber accesses the first link, a new link is generated and sent to the subscriber at the same e-mail address as the first link. In one embodiment, once the subscriber accesses the link, the attachment is sent by e-mail. In one embodiment, if a subscriber attempts to access the link and the link is not valid, the mailing list system checks whether the link was sent to a subscriber of the mailing list and if not, the user is presented with a web page allowing the user to subscribe by indicating what information he would like to have and entering an email address. After subscribing, a new link for accessing the information is generated by the mailing list system and sent to the subscriber at the entered e-mail address.

Exemplary embodiments of the present invention have many advantages. Storing information remotely, which would otherwise be an attachment in an e-mail message sent to members of a mailing list, and, instead, providing access to the information stored remotely prevents large attachments from being sent to members of a mailing list. A link to the information allows a mailing list system to control access to the information, such as not making the information public, authorizing or validating access, or controlling the number of times the information may be accessed or a time period during which the information may be accessed. A one-time clickable link provides a more secure and simple approach to providing information to a group of subscribers in place of using public links. No change needs to be made to e-mail clients and no additional software needs to be installed by the end user. Exemplary embodiments are server-based, not client-based.

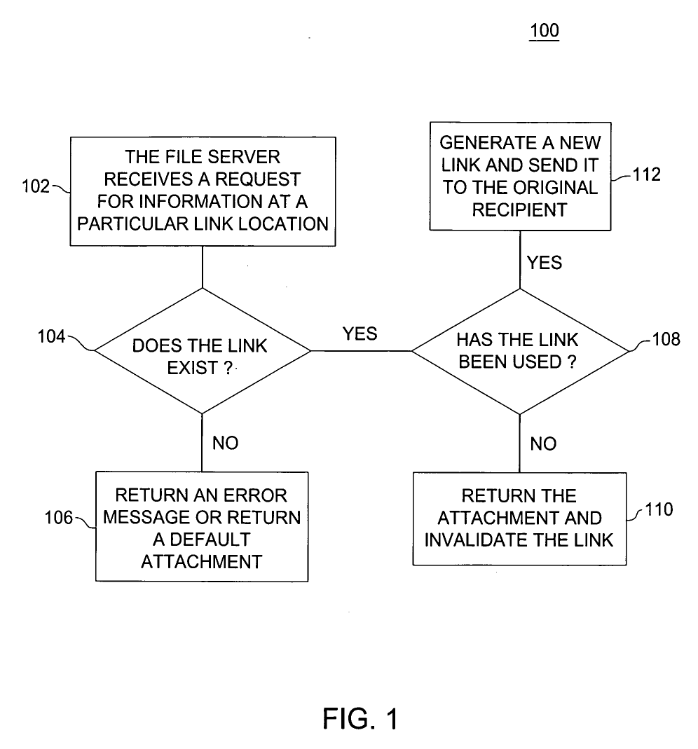

FIG. 1 shows an exemplary embodiment of a method 100 of responding to a subscriber request for an attachment. At 102, a file server receives a request for information at a particular link location. At 104, it is determined whether the link exists. If not, at 106 an error message or a default attachment is returned. If the link exists, at 108, it is determined whether the link has been used. If not, at 110 the attachment is returned and the link is invalidated. If the link has been used, at 112, a new link is generated and sent to the original recipient.

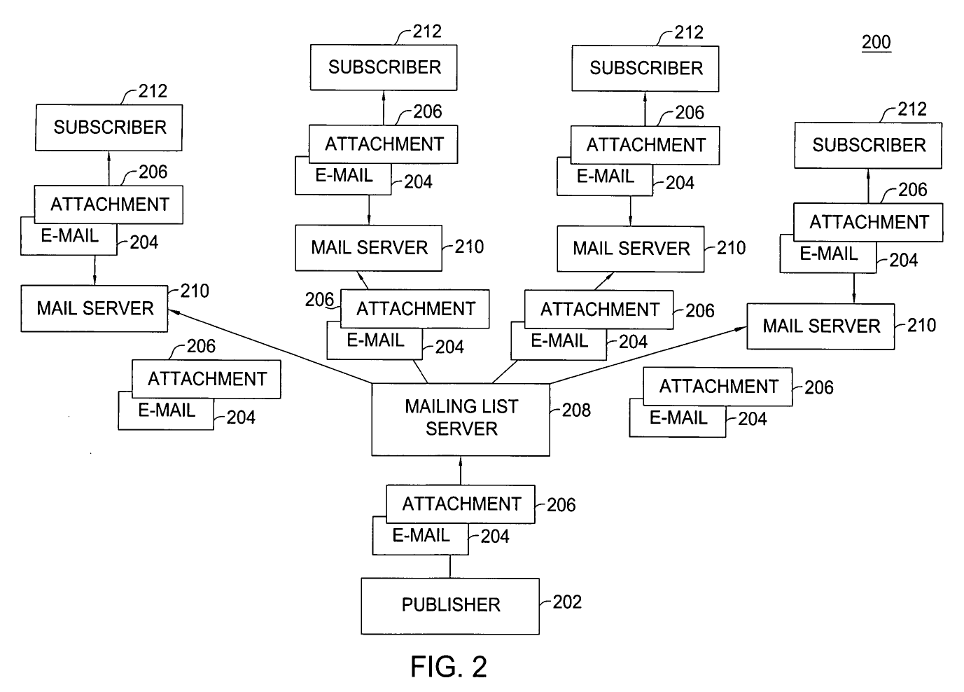

FIG. 2 shows a prior art system 200 for providing e-mail attachments to subscribers of a mailing list. A publisher 202 sends an e-mail message 204 having an attachment 206 to a mailing list server 208. The mailing list server 208 send the e-mail message 204 with the attachment 206 to a number of mail servers 210. Each subscriber 212 obtains the e-mail message 204 with the attachment 206 from his or her mail server 210.

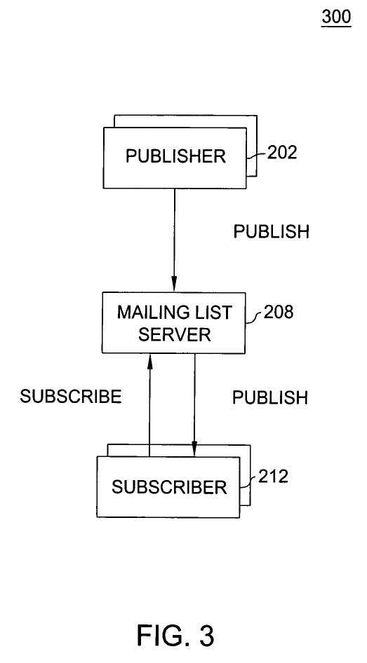

FIG. 3 shows an exemplary embodiment of a method 300 of providing a mailing list. The publisher 202 publishes an e-mail message 204 having a link in place of an attachment to the mailing list server 208. The mailing list server 208 publishes the e-mail message 204 having the link to the subscriber 212, who subscribes to the mailing list.

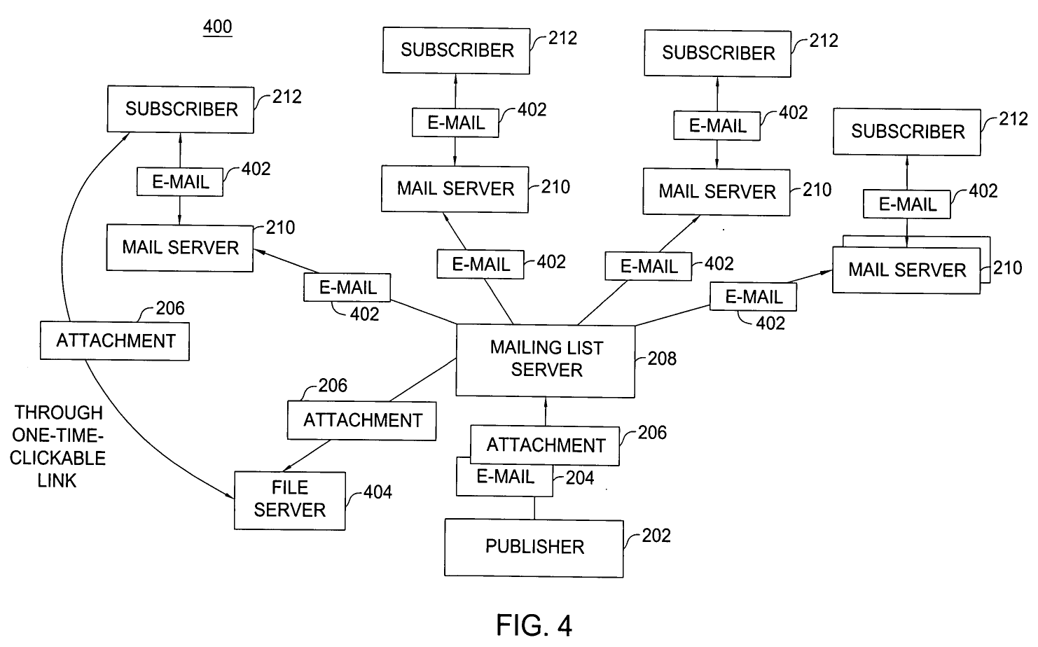

FIG. 4 shows an exemplary embodiment of a system 400 for sending a link instead of an e-mail attachment to subscribers of a mailing list. In this exemplary embodiment, the process of distributing messages to subscribers 212 on a mailing list is split into two parts: (1) publishing the information on the mailing list and (2) receiving the information from the mailing list.

First, the publisher 202 publishes information on the mailing list by sending an e-mail message 204 with an attachment 206 to a specific e-mail address, which is received and further processed by a mailing list server 208. The mailing list server 208 extracts the attachment 206 from the message and stores the attachment at a file server 404 or any storage facility that is accessible by the subscribers 212. For each subscriber 212, the mailing list server 208 generates a one-time clickable link, stores the link associated with the e-mail address of the subscriber 212, and forwards the e-mail with the link 402 to the subscriber 212 according to regular mailing list procedures. In one embodiment, the one-time clickable link is unique. In one embodiment, the link is not easy to reproduce by other entities. One advantage of not sending attachments to the subscribers 212 is to decrease the load on the network(s) that interconnect the mailing list server 208 and the mail servers 210. Also, subscribers 212 are not surprised by the arrival of e-mail messages 204 with large attachments 206 that may take some time to download.

Second, information is received from the mailing list. The subscriber 212 receives information from the mailing list by checking his mail. When the subscriber 212 checks his mail, the mail server 210 is contacted and provides any newly received e-mail messages and other e-mail messages. To receive the attachment, the subscriber 212 selects the link in the email message 402 that replaced the attachment 206. When a request for the attachment 206 is received, it is determined whether the link exists. Because, in one embodiment, the link is unique and non-reproducible, it can be determined whether the link has been generated by a particular mailing list server 208 or file server 404. If the link does not exist, an error message or a default attachment can be returned. If the link exists, it is determined whether the link has already been used. For example, a subscriber 212 may have forwarded to the link to a non-subscriber. A one-time clickable link makes it harder for subscribers 212 to forward information to non-subscribers. If the link has already been used, a new link is generated, stored, validated, and sent to the original subscriber 212, who received the old link. In this way, the subscriber 212 has an opportunity to obtain the attachment again, but it is more difficult for others to retrieve. If the link has not been used before, the attachment is returned and the link is invalidated.

One purpose of a mailing list is to distribute information only to a limited group of people. Exemplary embodiments make it harder for subscribers 212 to effectively forward e-mail messages 204 from the mailing list to those outside the group. At the same time, the load on the network is decreased, while maintaining ease of use. In one embodiment, security is increased by access control or encryption.

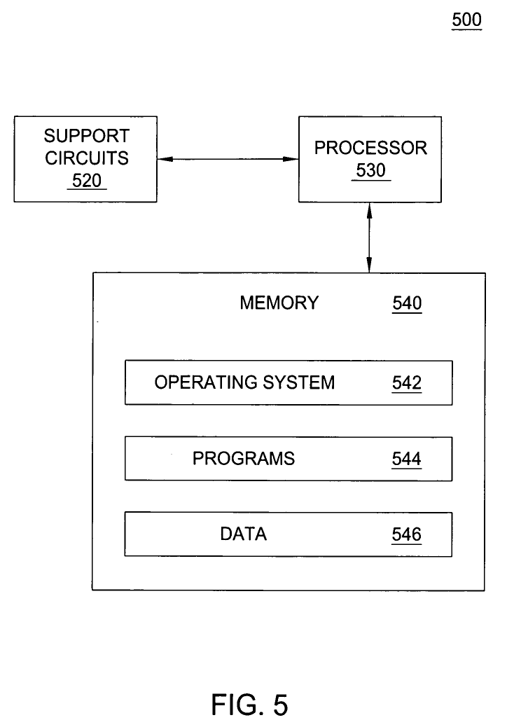

FIG. 5 is a high level block diagram showing a computer. The computer 500 may be employed to implement embodiments of the present invention. The computer 500 comprises a processor 530 as well as memory 540 for storing various programs 544 and data 546. The memory 540 may also store an operating system 542 supporting the programs 544.

The processor 530 cooperates with conventional support circuitry 520 such as power supplies, clock circuits, cache memory and the like as well as circuits that assist in executing the software routines stored in the memory 540. As such, it is contemplated that some of the steps discussed herein as software methods may be implemented within hardware, for example, as circuitry that cooperates with the processor 530 to perform various method steps. The computer 500 also contains input/output (I/O) circuitry that forms an interface between the various functional elements communicating with the computer 500.

Although the computer 500 is depicted as a general purpose computer that is programmed to perform various functions in accordance with the present invention, the invention can be implemented in hardware as, for example, an application specific integrated circuit (ASIC) or field programmable gate array (FPGA). As such, the process steps described herein are intended to be Obroadly interpreted as being equivalently performed by software, hardware, or a combination thereof.

The present invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast media or other signal bearing medium, and/or stored within a working memory within a computing device operating according to the instructions.

While the foregoing is directed to various embodiments of the present invention, other and further embodiments of the invention may be devised without departing from the basic scope thereof. As such, the appropriate scope of the invention is to be determined according to the claims, which follow.

What is claimed is:

1. A method for processing messages, comprising:
storing information from an attachment in an e-mail message, before the e-mail message is sent to a plurality of subscribers to a mailing list;
replacing the attachment in the e-mail message with a link for accessing the information from the attachment, before the e-mail message is sent to the subscribers;
sending the e-mail message with the link to the subscribers; and
providing the information from the attachment, when one of the subscribers clicks on the link.

2. The method of claim 1, wherein the link is unique for each subscriber.

3. The method of claim 1, wherein the link is valid for a predetermined time period.

4. The method of claim 1, wherein the link is valid for a predetermined number of accesses.

5. The method of claim 4, wherein the predetermined number of accesses is one.

6. The method of claim 1, further comprising:
performing validation before providing the information from the attachment.

7. A system for processing messages, comprising:
a mailing list server to receive an e-mail message with an attachment and to send a modified e-mail message having the attachment replaced by a link to a plurality of subscribers via a plurality of mail servers; and
a storage device that is accessible by the mailing list server, the storage device to store the attachment and to provide the information from the attachment when one of the subscribers clicks on the link.

8. The system of claim 7, wherein the link is unique for each subscriber.

9. The system of claim 7, wherein the link is valid for a predetermined time period.

10. The system of claim 7, wherein the link is valid for a predetermined number of accesses.

11. The system of claim 7, wherein the predetermined number of accesses is one.

12. The system of claim 7, further comprising:
a security mechanism to perform validation before providing the information from the attachment.

13. A computer readable medium storing instructions for performing a method for processing messages, the method comprising
storing information from an attachment in an e-mail message, before the e-mail message is sent to a plurality of subscribers to a mailing list;
replacing the attachment in the e-mail message with a link for accessing the information from the attachment, before the e-mail message is sent to the subscribers;
sending the e-mail message with the link to the subscribers; and
providing the information from the attachment, when one of the subscribers clicks on the link.

14. The computer readable medium of claim 13, wherein the link is unique for each subscriber.

15. The computer readable medium of claim 13, wherein the link is valid for a predetermined time period.

16. The computer readable medium of claim 13, wherein the link is valid for a predetermined number of accesses.

17. The computer readable medium of claim 13, wherein the predetermined number of accesses is one.

18. The computer readable medium of claim 13, further comprising:
performing validation before providing the information from the attachment.
